(19) United States
(12) Patent Application Publication
(10) Pub. No.: US 2010/0185930 A1
(43) Pub. Date: Jul. 22, 2010

(54) METHOD AND APPARATUS FOR INCORPORATING APPLICATION FUNCTIONALITY INTO A WEB PAGE

(75) Inventors: Geoffrey Matsushita Scott, Williston Park, NY (US); Tushar Kirit Shah, Edison, NJ (US); Manohar Reddy Nallaballe, Montvale, NJ (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: AUTOMATED RESOURCES GROUP, LLC, Montvale, NJ (US)

(21) Appl. No.: 12/691,436

(22) Filed: Jan. 21, 2010

Related U.S. Application Data
(60) Provisional application No. 61/205,570, filed on Jan. 22, 2009.

(51) Int. Cl. G06F 15/16; G06F 17/00

(52) U.S. Cl. 715/222; 709/203

(57) ABSTRACT

A method and system incorporate server-side application functionality into client-side web pages. A web page includes a script tag that identifies a location on a server from which to acquire script code when a browser processes the script tag. An application running on the server receives a request for a data entry form when the browser executes script associated with the script tag. In response to this request, the application generates the data entry form, in one embodiment configuring attributes of the data entry form in accordance with user-supplied information. The application transmits the data entry form to the browser and maintains a state of user interaction with the data entry form. The application can subsequently capture and save user-supplied data submitted through the data entry form, and, based on the captured user-supplied data, state of user interaction, or both, determine a next screen presentation for the browser to render.

### RELATED APPLICATION

This application claims the benefit of U.S. Provisional Application Ser. No. 61/205,570, filed Jan. 22, 2009, titled “Method and Apparatus for Incorporating Application Functionality into a Web Page,” the entirety of which provisional application is incorporated by reference herein.

### FIELD OF THE INVENTION

The invention relates to Web application architecture. More specifically, the invention relates to incorporating server-side application functionality into client-side Web pages.

### BACKGROUND

Websites are the mainstay of the World Wide Web, commonly referred to as “the Web”. In general, a web site is a collection of related web pages that share a common domain name or Internet Protocol address. Web pages are structured electronic documents written in a markup language, a predominant form being HTML (Hypertext Markup Language). Web servers host web sites, and are accessible to users over a network, such as the Internet. To access web pages of a website, a user runs a software application, known as a browser, on their device. The browser retrieves a web page from a web server based on its URI (Uniform Resource Identifier), parses the code of the downloaded web page, and presents content on the screen of the user's device. The type of content presented by the rendered web page, and the manner of its presentation, appear limited only by the human imagination.

Many websites and browser-based applications include data entry forms for capturing user input. Usually, these data entry forms are implemented as HTML tags within a web page. When a user submits data entered into a data entry form, the browser triggers HTTP (Hypertext Transport Protocol) POST operations that communicate with application logic on the web server to process the submitted data. HTTP is the communications protocol used to retrieve interlinked documents on the Web, and POST is a method of the HTTP protocol that enables the submission of data, typically through an HTML form, to a web server.

When the application logic needs to incorporate third-party functionality from another application, from a licensed software product, or from a hosted application service provider, it typically invokes a form of remote procedure call using techniques such as SOAP (Simple Object Access Protocol), REST (Representational State Transfer), XML-RPC (eXtensible Markup Language-Remote Procedure Call), or other standard or proprietary techniques. SOAP is a protocol specification for exchanging structured information in the implementation of web services in computer networks, REST is a style of software architecture for distributed hypermedia systems, such as the Web, XML is a general-purpose specification for creating custom markup languages, and XML-RPC is a remote procedure call protocol which uses XML to encode its calls and HTTP as a transport mechanism.

When the third-party functionality changes to add, remove, or alter data elements in a data entry form, modifications are usually needed, both to the data entry form and to the application logic that invokes the third-party functionality, to accommodate these changes. Moreover, such modifications typically require skilled software developers to implement them, often involving significant investment of time and money.

### SUMMARY

In some aspects, the invention features a method and computer program product for integrating application functionality into a web page requested and rendered by a browser of a client computing system. A script tag is generated for embedding in a web page. The script tag identifies a location on a server from which to acquire script code to be executed when a browser of a client computing system processes the script tag. An application running on the server transmits the script code to the browser in response to the browser processing the script tag. The application running on the server receives a request for a data entry form in response to execution of the script code by the browser, generates the data entry form in response to the request from the browser; and transmits the generated data entry form to the browser.

In another aspect, the invention features a system for integrating application functionality into a web page, comprising a client computing system running a browser that requests a web page from a web server. The browser program processes a script tag embedded in the requested web page. The script tag identifies a location from which to acquire script code to be executed by the browser. A server computing system runs an application that transmits the script code to the browser running on the client computer system in response to the browser processing the script tag. The application receives a request for a data entry form in response to execution of the script code by the browser, generates the data entry form in response to the request from the browser, and transmits the generated data entry form to the browser.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of an embodiment of a network environment in which the principles of the invention may be practiced.

FIG. 2 is a diagram of an embodiment of a data entry form.

FIG. 3A and FIG. 3B are a flow diagram of an embodiment of a process for incorporating application functionality into a web page.

FIG. 4 is a flow diagram of an embodiment of a process for generating and updating a data entry form.

FIG. 5 is a diagram of an embodiment of a form through which an end user can configure the data entry form of FIG. 2.

### DETAILED DESCRIPTION

Described herein are methods and apparatus for incorporating application functionality into a web page by embedding into the web page a single line of code, in particular, a script tag that references a web-based application located at a server. In brief overview, when a user computer device requests and receives the web page, the user's browser parses the script tag, causing retrieval and execution of script code (e.g., JavaScript) to which the script tag refers. Upon executing this script code, the browser communicates with the web-based application on the server, requesting that the application provide specified functionality. The application responds to the request by performing the specified functionality and returning the results to user's computer device, where the browser renders the results; thereby integrating the functionality of the application into the web page.

The particular functionality provided by the application depends upon the target audience. The application can be configured to facilitate common audience interactions by presenting one or more data entry forms in the web page. Examples of such audience interactions include, but are not limited to, registering a user, logging in, searching a web site, conducting e-commerce, providing a shopping cart, updating payment methods, renewing subscriptions, placing subscriptions on hold, and managing a user profile.

In addition, the application provides services for processing user-supplied information through a form presented on the web page and maintains the state of the user interaction (separately of the web page). Maintaining state enables the application to present, for example, a sequence of related data entry forms, commonly known as a wizard, or to redirect the browser to another web page, all in response to a single processing of the embedded script tag. Further, data entry forms embedded on the same web page or on different web pages can exchange information and interact with each other.

Web site owners or managers can choose from a variety of audience interactions to incorporate into their web pages, simply by copying and pasting specific script tags into the web pages. For example, one script tag can be used to incorporate a login form into the web page, whereas another script tag serves to incorporate a registration form. This copy and paste process is advantageous over conventional methods, which typically involve a comparatively time-consuming manual process of developing software to implement the presentation layer of the web page (i.e., its field labels, user interface controls, and behavior) and underlying functionality to process user input.

In addition, web owners, managers, and their employees can configure and reconfigure these data entry forms, as desired, through a user interface provided by the application, in order to fine-tune the incorporated functionality for their target audience, without the need to involve software developers, information technologists, or vendors, and without having to change any software code or scripts in the web page or of the application. Reducing the complexity of these tasks to the skills of ordinary personnel is more advantageous than having to outlay the expense and time to employ a software developer with the right skills, training, and experience to make the changes.

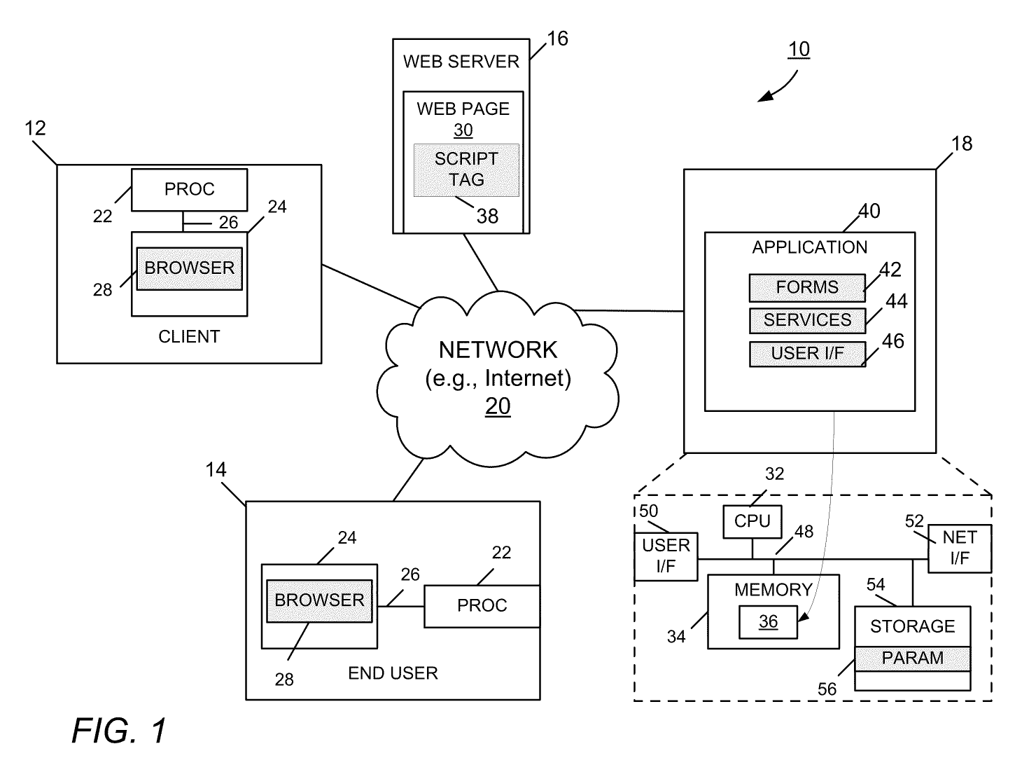

FIG. 1 shows an embodiment of a network environment 10 including a client computing system 12, an end-user computing system 14, a web server 16, and a server 18 connected to a network 20. Examples of the network 20 include, but are not limited to, local-area networks (LAN), metro-area networks (MAN), and wide-area networks (WAN), such as the Internet.

The client computing system 12 (hereafter, client) and the end-user computing system 14 (hereafter, end-user) each includes a processor 22 in communication with memory 24 over a communication bus 26. The communication bus 26 also connects the processor 22 to various other components (not shown), such as a user interface, a display (e.g., a video monitor), and a network interface. The user interface is in communication with one or more user-input devices (e.g., a keyboard, a mouse, trackball, touch-pad, touch-screen, microphone, and joystick) by which a user can enter information and commands.

The memory 24 includes non-volatile computer storage media, such as read-only memory (ROM), and volatile computer storage media, such as random-access memory (RAM). Stored in the ROM may be a basic input/output system (BIOS), which contains program code for controlling basic operations of the computing system, including start-up of the client and initialization of hardware. Stored within the RAM are files of program code and data. Program code includes, but is not limited to, application programs, program modules, plug-ins, and an operating system. The non-volatile storage may be removable or non-removable storage media, examples of which include, but are not limited to, hard disks, USB memory sticks, optical disks such as CD ROMs, magnetic diskettes, and flash memory cards.

Application programs on the computing systems 12, 14 include, but are not limited to, a web browser 28 for accessing and downloading structured electronic documents (referred to herein as web pages) written in a markup language, for example, HTML, from web servers (such as server 16) and application servers (such as server 18) over the network 20. Examples of Internet browsers for downloading web pages include, but are not limited to, Microsoft® Internet Explorer™, Google® Chrome™, and Mozilla® Firefox®.

The web browser 28 is enabled to execute code written in a scripting language, such as JavaScript, VBScript, Jscript, and XUL (XML User Interface Language). Code written in a scripting language can perform tasks not otherwise possible using HTML code alone. The particular scripting language used in a web page may limit the particular web browser that is able to execute that scripting language code. For instance, presently VBScript works only in the Microsoft® Internet Explorer™. In contrast, JavaScript works with many popular browser platforms, such as Microsoft® Internet Explorer™, Google® Chrome™, and Mozilla® Firefox®.

Example implementations of the client and end-user computing systems 12, 14 include, but are not limited to, a personal computer (PC), Macintosh® computer, MacBook® computer, a workstation, a kiosk, laptop computer, server system, hand-held device, such as a personal digital assistant (PDA), a mobile or cellular phone, and network terminal. Examples of operating systems that can run on the client and end-user computing systems include, but are not limited to, Windows XP®, Vista®, Windows 7, Linux, and Macintosh® OS). Although each is shown as a single bus, the communication busses 26 can comprise multiple separate busses, which may be of different types. Example implementations of the communication busses 26 include, but are not limited to, a Peripheral Component Interconnect (PCI) bus, an Industry Standard Architecture (ISA) bus, an Enhanced Industry Standard Architecture (EISA) bus, and a Video Electronics Standards Association (VESA) bus.

The web server 16, in general, is a computer system connected to the network 20 for maintaining web sites and serving web pages to client browsers (such as browser 28 of client 12) using HTTP (or HTTPS). A web page 30 residing at the web server 16 has an embedded script tag 38. In general, the web page 30 with the script tag 38 can contain any content and provide any functionality. In one embodiment, this scripting language identified in the script tag 38 is JavaScript. The script tag 38 references a URI associated with a web-based application on the server 18 and can have the following general format:

<script language=“javascript”>src=“URI” !—Where URI points to a script at an IP address of the server 18 and identifies a particular data entry form </script>

The web page 30 can have multiple script tags, each referencing a different configurable interactive data entry form.

To download the web page 30 from the web server 16, the client 12 can connect to the network 20 through one of a variety of connections including, but not limited to, standard telephone lines, digital subscriber line, LAN or WAN links (e.g., T1, T3), broadband connections (Frame Relay, ATM), and wireless connections (e.g., 802.11(a), 802.11(b), 802.11(g)).

The server 18 includes a processor 32 in communication with memory 34 over a bus 48. The memory 34 stores program code 36 and data. The program code 36 includes an application 40 with application logic tailored to provide particular functionality to be incorporated into a downloaded web page, as described herein. The server 18 also includes a user interface 50, a network interface 52, and storage 54, which may be removable or non-removable storage media, examples of which include, but are not limited to, hard disks, USB memory sticks, optical disks such as CD ROMs, magnetic diskettes, and flash memory cards. The storage 54 maintains a persistent database that holds configuration parameters 56, as described further below.

The application 40 includes configurable interactive data entry forms 42, processing services 44 for supporting the presentation and functionality of these forms, and an application user interface 46 through which (authorized) end-users can configure and reconfigure such presentation and functionality. An example of a configurable data entry form is a data entry form for registering a user. In general, the particular presentation and functionality integrated into a downloaded web page depends upon the particular data entry form referenced by the script tag 38, configuration parameters supplied by an end-user for that data entry form, user input supplied to the presented data entry form, and the application logic of the application 40.

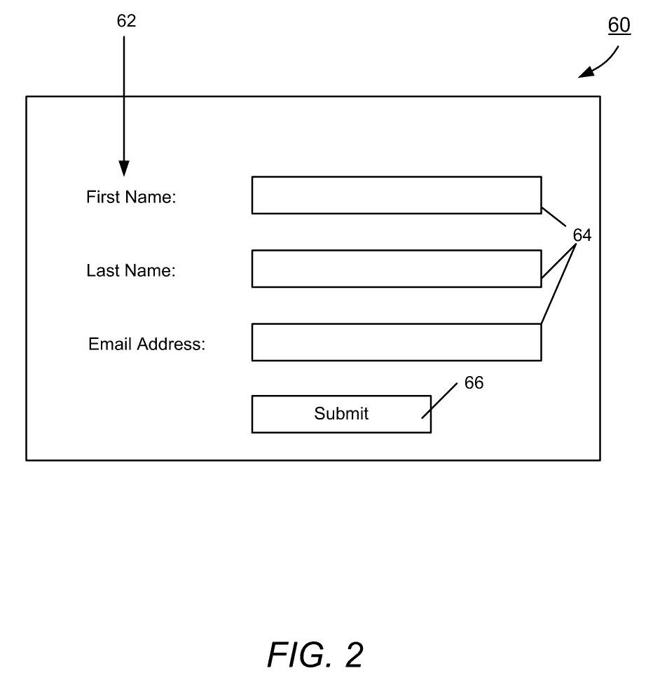

Referring to FIG. 2, shown is a simplified example of a data entry form 60 that the application 40 can cause to be presented at the client 12. The data entry form 60 includes field labels 62, user interface controls 64 for receiving user-supplied values, and a submit button 66 which, when activated, causes user-supplied values to be transmitted to the application 40 at the server 18. The application 40 provides all of the application logic that generates and supports the data entry form 60, for example, the appearance of the form, the location of the field labels and their corresponding user interface controls, any configured user input validation, and the processing of the form after the form is submitted. Having the application 40 provide all of the application logic eliminates the need for such application logic on the web page 30.

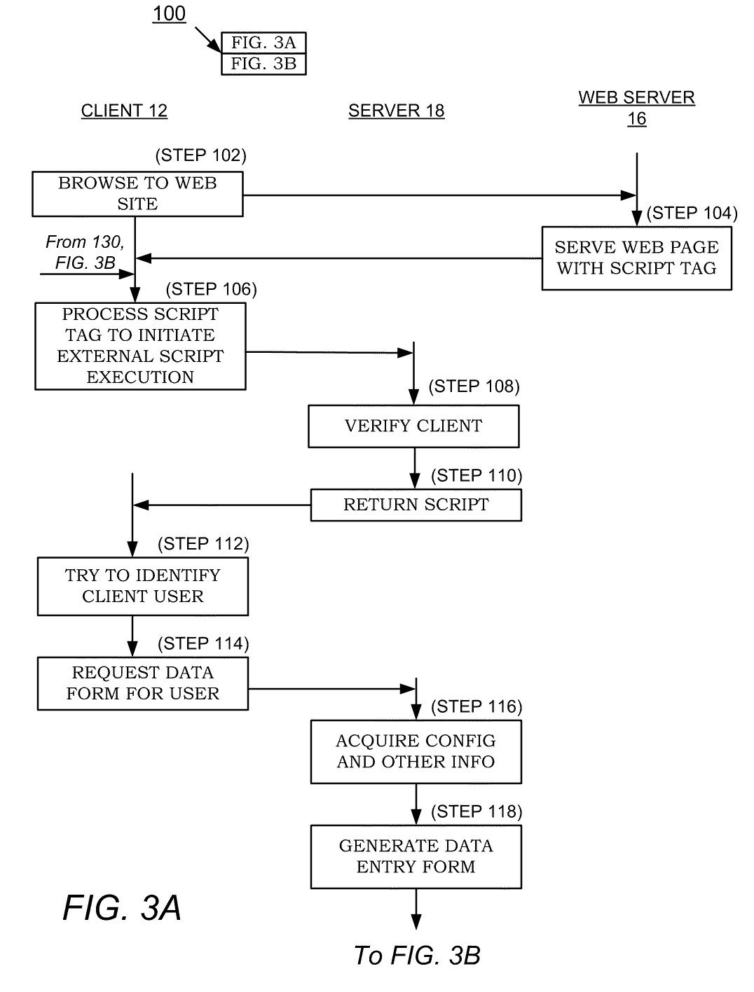

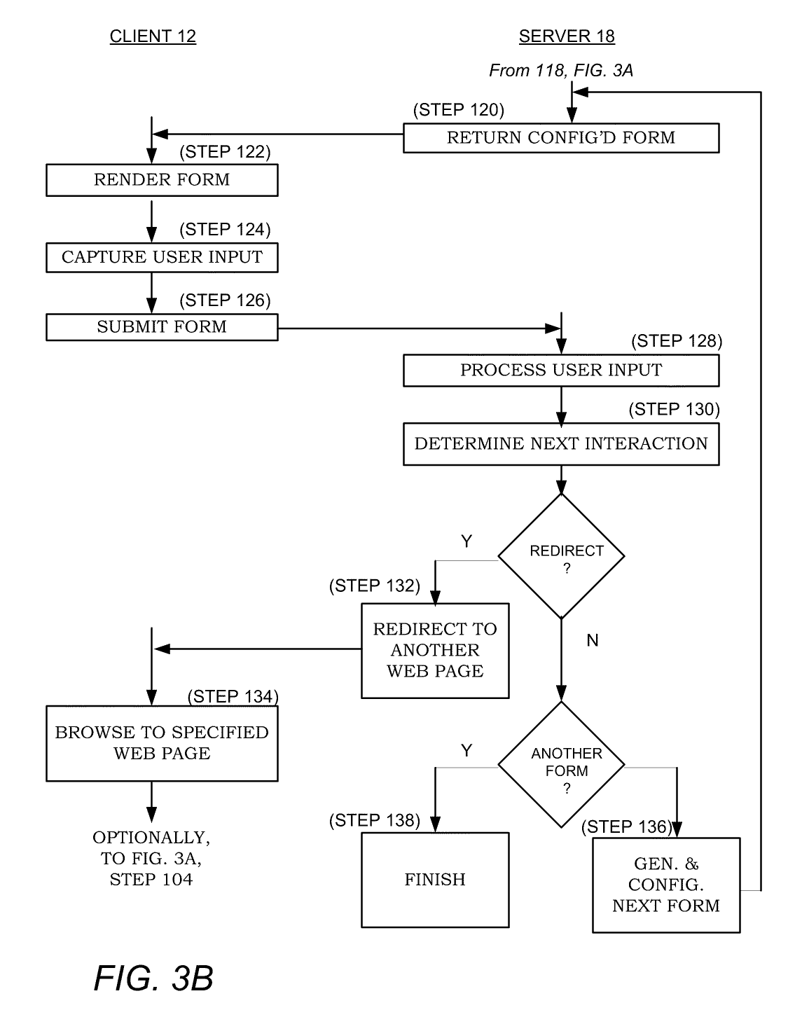

FIG. 3A and FIG. 3B show an embodiment of a process 100 for integrating application program functionality into a web page. This description of the process also refers to items in FIG. 1 and FIG. 2. At step 102, a user of the client 12 launches the web browser 28 and sends a request to the web server 16 to download the web page 30 with the embedded script tag 38. The script tag 38 specifies the URI location of a script used to present an interactive data entry form, for example, the data entry form 60, when executed.

In response to the request, the web server 16 sends (step 104) the web page 30 to the client. When parsing the HTML code of the downloaded web page, or in response to a trigger event such as a mouseover, the browser at the client processes (step 106) the script tag and sends a request to the specified URI location (here, server 18) to retrieve script code associated with the specified interactive data entry form. The application logic of the application 40 running on the server 18 parses the request, and generates a cookie. This cookie is a text file containing small amounts of information to be used by the application 40 in maintaining state of the user interaction with the data entry form. This application logic of the application 40 handles subsequent requests from the browser based on the current state of the user interaction with the data entry form. The application 40 can use the cookie for other purposes, examples of which include, but are not limited to, performing user authentication, maintaining site preferences, and storing electronic shopping cart contents.

In response to this request for the specified script, the application 40 may attempt to verify (step 108) whether the client user is authorized before returning the script code to the client browser. Provided the user is authorized, the application 40 returns (step 110) the script code associated with the specified interactive data entry form, which the browser executes upon receipt. Such execution by the client browser initiates the process of acquiring the specified interactive data entry form from the server 18.

Before requesting the data entry form, the script code attempts (step 112) to identify the user of the client. If the script code cannot identify the user, the user remains anonymous. The script code then sends (step 114) a request to the application 40 on the server 18 to acquire the specified data entry form, configuration parameters appropriate for the user and for the data entry form and, optionally, any appropriate user data. For example, an identified user may have previously submitted information to be used with this data entry form, such as first and last names, whereas an anonymous user, for whom no associated information is presently available, may receive a blank data entry form.

In response to the request for the data entry form and related configuration information, the application 40 accesses (step 116) the database implemented in storage 58 to acquire the appropriate configuration for the user and for this particular data entry form. Such configuration information includes the field labels, user interface controls, and behaviors to be given to the data entry form. User interface controls include, but are not limited to, text boxes, text areas, check boxes, radio buttons, lists, and selections. Behaviors include, but are not limited to, user input validation, transitions to other data entry forms on form submission, and transfer to other Web pages on form submission.

At the server 18, the application 40 responds to this request by dynamically generating (step 118) the data entry form in accordance with the related configuration information retrieved from the database, and, optionally, populates fields of the data entry form with user-specific data. The application 40 then returns (FIG. 3B, step 120) this configured (and optionally populated) data entry form to the client browser. This data entry form, as returned by the server to the client browser, can be embodied by a structured electronic document (e.g., an HTML page), and can have references to other script code and web pages. The application 40 may also return to the browser any user-supplied values or state information previously received, for example, through previously submitted forms.

Upon its receipt, the browser renders (step 122) the data entry form in accordance with this received information, namely, the configuration parameters, values, and state information applied to the data entry form by the application 40. For example, one end user may have configured the data entry form to display five fields of information: first name, last name, company, email address, and phone number; accordingly, the screen presentation produced by the browser accessing this configuration of the data entry form has these five fields. Another end user may have configured this same data entry form to have only three fields: first name, last name, and email address; accordingly, for this end user, the screen presentation produced according to this configuration of the data entry form has these three fields. As used herein, a screen presentation of a given data entry form encompasses the appearance, user interface controls, and behavior of the data entry form (i.e., not just the appearance).

In addition, depending upon the current state of user interaction, the returned values may include previously received user-supplied values, such as the first and last names of the user, and the first and last name fields in the data entry form are automatically populated with these returned values. If, on the other hand, the state of user interaction is such that the displayed data entry form is the first in a sequence of data entry forms, and the first and last name values are not yet available, the corresponding fields in the data entry form are empty.

At step 124, the data entry form 60 captures values inserted by the user in the various fields. Depending upon the particular configuration of the data entry form, the browser can communicate with the application 40 on the server as the user moves from one field of the data entry form to another field, and the application 40 can validate or invalidate the present state of the form. For example, while entering information into the form, the user may skip over a required field, such as email address, leaving the field empty (i.e., blank). Moving from this empty field causes the data entry form to send the contents of the field to the application 40. The application logic of the application 40 can then determine that the contents are empty, and that this is an invalid condition. In response, the application 40 returns an error message to the browser, which appears atop the data entry form and prevents the user from moving further without responding to the error (such as by entering a valid email address in the field).

When the user activates the submit button 66, the captured values pass (step 126) to the processing services 44 of the application 40. Upon receiving the values submitted through the data entry form, the processing services 44 perform (step 128) certain functions using those values. The particular functions performed by the processing services depend upon the application logic to be followed and the current state of user interaction with the data entry form. For example, the application logic may require the processing services to send an acknowledgement email in response to receiving an email address from the data entry form. Another example of a function performed by the processing services is to save the captured user-supplied values in the configuration database.

In addition, after completing those functions, the processing services 44 determine (step 130) the next user interaction, if any, to initiate. For example, the processing services determine whether to present another data entry form to the client system, or to re-direct the client browser to another web page. The particular interaction to initiate depends upon the current state of the user interaction. For instance, the state of the user interaction can indicate that the user is finished with the downloaded web page and is ready for a subsequent web page (e.g., a shopping cart page). Based on this current state of user interaction, the processing services redirects (step 132) the client browser to the new web page, which the browser downloads (step 134) and displays. That new web page can have an embedded script tag, like the previously described web page 30, and the process of acquiring a new script that incorporates application program functionality repeats from step 104.

As another example, the current state of the user interaction can be that the user has just completed the initial data entry form in a sequence of forms. Based on this state, the processing services of the application 40 select the next form in the series, generate and configure the next form, and send (step 136) the next form to the client browser. Accompanying the next form can be values supplied by the user through the previous form and state information needed by the next form. For this next form, the actions of displaying and capturing information are similar to those for the previous form (i.e., the process can continue from step 122).

Alternatively, the current state of the user interaction can indicate that the user has completed the interaction, and the processing services terminate (step 138) the process (e.g., closes the wizard, displays a “transaction complete” screen).

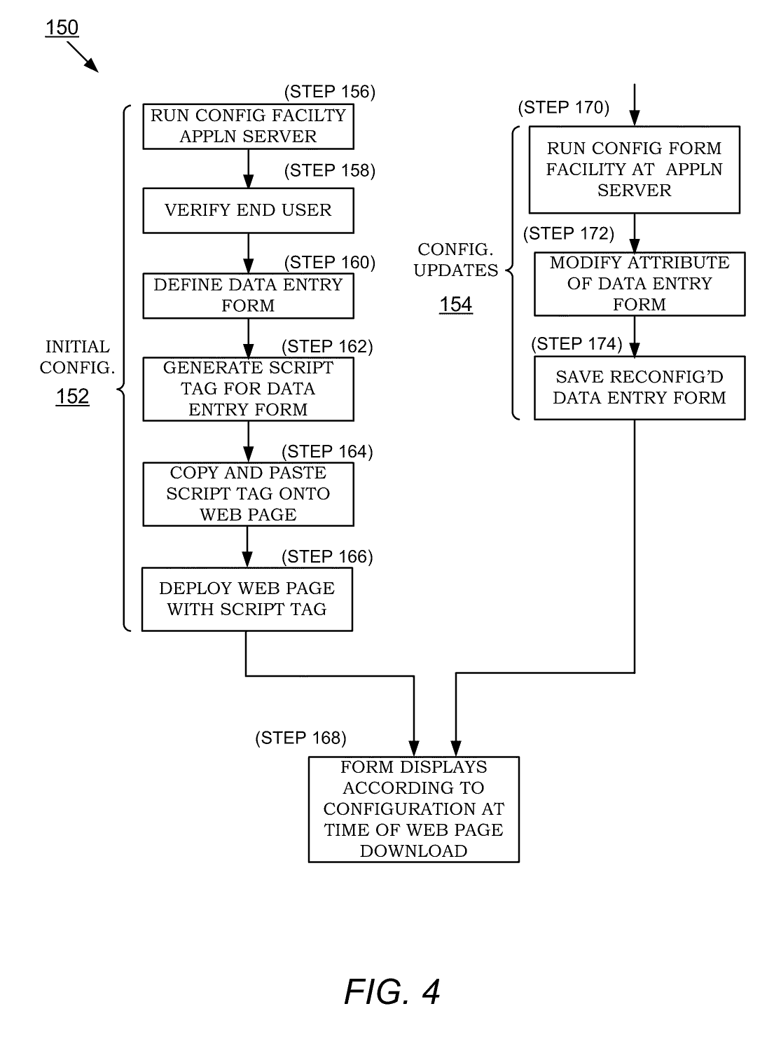

FIG. 4 shows an embodiment of a process 150 for initially configuring and updating a data entry form. The process 150 includes an initial configuration stage 152 and maintenance stage 154. The description of the process 150 refers to various items shown in FIG. 1. During the initial configuration stage, the end-user 14 browses (step 156) to the server 18 and, through a configuration facility of the user interface 46 provided by the application 40, selects a data entry form for configuration. For example, the end-user may want to incorporate a registration form in his web page, and, thus, selects the registration form for custom configuration. Another end-user may want to incorporate a login form in her web page, and, thus, selects the login form for custom configuration.

The processing services 44 verifies (step 158) whether the end-user is authorized to configure the selected data entry form. After verification, the end-user defines (step 160) various attributes of the selected data entry form, for example, the field labels, the user interface controls, behavior, color, and font. As part of the configuring the data entry form, the end-user provides the identity of the web page with which the data entry form is to be associated, and the identities of any other web pages to which a visitor of that web page is to be redirected.

After the end user finishes defining various attributes of the data entry form, the application 40 generates (step 162) a script tag that links to this data entry form. The end-user copies this script tag (e.g., into a clipboard buffer) and pastes (step 164) the script tag into the target web page. The end-user deploys (step 166) the web page with the embedded script tag at a web site. Any client browser subsequently downloading this web page renders (step 168) the data entry form, in a manner described previously in connection with FIG. 3A and FIG. 3B. The data entry form appears and functions as initially configured by the end-user. In addition, the application 40 saves the settings for the configured attributes in the database (storage 58) and associates these configuration parameters with the web page (thus, a request from the script tag on the web page can be matched with the appropriate configuration parameters).

At a time subsequent to the initial deployment, the end-user may want to modify the screen presentation (appearance, user-interface controls, or the behavior) of the initially configured data entry form. The end-user again accesses the user interface 46 and, after verification, selects (step 170) the particular data entry form to be modified (e.g., registration form, login form, search form, etc). The end user can modify (step 172) any of the attributes, such as the field labels, user interface controls, and behaviors of the data entry form. At step 174, the end user saves the newly modified data entry form (as updated configuration parameters). After being saved, these modifications are reflected in the rendered data entry form the next time a client browser downloads the web page with the embedded script tag. Thus, the end user has changed the functionality of the web page (more specifically, the data entry form presented within the web page) without changing the code of the web page, its embedded script tag, or the software code of the application 40.

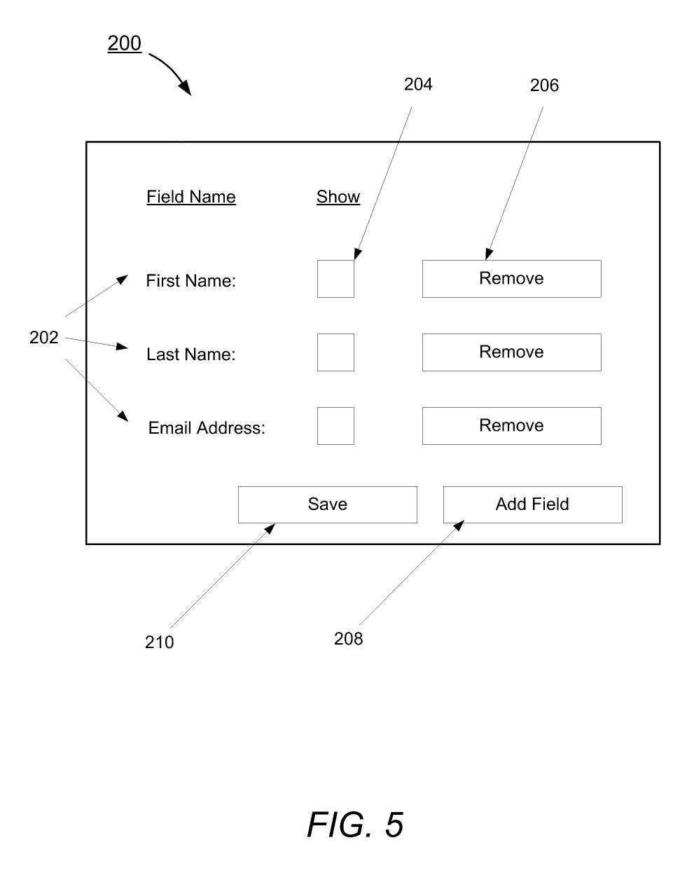

Referring to FIG. 5, shown is an example of a configuration screen 200 that the user interface 46 can present to the end-user for modifying, as an example, the configuration of the data entry form 60 of FIG. 2. The configuration screen 200 includes names of fields 202 currently defined for the data entry form 60. Near each field name is a checkbox 204 for selecting (with an input device) the associated field; selecting causes that field name to appear in the screen presentation of the data entry form, deselecting causes the field to be omitted from the data entry form. Also near each field name is a remove button 206 for removing that field completely from the data entry form (once removed, the field does not appear within the configuration screen 200, but can be later restored through the add field button 208).

The configuration screen 200 also includes an add field button 208 and a save button 210. The add field button 208 corresponds to a function that allows the end-user to define a new field to be included in the data entry form. By the save button 210, the end-user saves any modifications to the configuration parameters associated with the data entry form. The configuration screen 200 can have other features and functions than those shown, for example, a cancel button by which to abort the modification process.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects. All such embodiments may be generally referred to herein as a “system”. Furthermore, aspects of the present invention may take the form of a computer program product embodied in one or more computer readable storage medium(s) having computer readable program code embodied thereon.

A computer readable storage medium may be any tangible medium that can contain, or store a program for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing. More specific examples of the computer readable storage medium include, but are not limited to, the following: a portable computer diskette, a hard disk, a random access memory (RAM), a read-only memory (ROM), an erasable programmable read-only memory (EEPROM, EPROM, Flash memory), an optical fiber, a portable compact disc read-only memory (CD-ROM), an optical storage device, a magnetic storage device, or any suitable combination of the foregoing.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

Aspects of the present invention are described below with reference to flowchart illustrations and/or block diagrams of methods, apparatus (systems), and computer program products according to embodiments of the invention. Each block of the flowchart illustrations and/or block diagrams, and combinations of blocks in the flowchart illustrations and/or block diagrams can be implemented by computer program instructions.

Computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Computer program instructions may also be stored in a computer readable storage medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the FIGs. illustrate the architecture, functionality, and operation of possible implementations of systems, methods, and computer program products according to various embodiments of the present invention. In this regard, each block in the flowchart or block diagrams may represent a module, segment, or portion of program code, which comprises one or more executable instructions for implementing the specified logical function(s). The functions noted in the blocks may occur out of the order noted in the FIGS. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A method for integrating application functionality into a web page requested and rendered by a browser of a client computing system, comprising:
generating a script tag for embedding in a web page, the script tag identifying a location on a server from which to acquire script code to be executed when a browser of a client computing system processes the script tag;
transmitting, by an application running on the server, the script code to the browser in response to the browser processing the script tag;
receiving, by the application running on the server, a request for a data entry form in response to execution of the script code by the browser;
generating, by the application running on the server, the data entry form in response to the request from the browser; and
transmitting the data entry form generated by the application running on the server to the browser.

2. The method of claim 1, further comprising receiving user-supplied input through a user interface of the application running on the server to configure attributes of the data entry form; and
wherein generating the data entry form, by the application running on the server, includes configuring the data entry form in accordance with the configured attributes before transmitting the data entry form to the browser.

3. The method of claim 1, further comprising receiving user-supplied input through a user interface of the application on the server to reconfigure attributes of the data entry form and, thereby, to change subsequent screen presentations of the data entry form, without modifying the script tag embedded on the web page.

4. The method of claim 1, further comprising maintaining, at the server, a state of user interaction with the data entry form.

5. The method of claim 1, further comprising communicating, by the application running on the server, with the data entry form rendered by the browser to produce a next screen presentation on the client computing system based on a state of user interaction with the data entry form.

6. The method of claim 5, wherein the next screen presentation is a next form.

7. The method of claim 5, wherein the next screen presentation is a new web page.

8. The method of claim 1, further comprising:
capturing, by the application running on the server, user input submitted through the data entry form; and
determining, by the application running on the server, a next screen presentation for the browser to render based on the captured user input submitted through the data entry form.

9. The method of claim 1, wherein the script tag is a JavaScript tag and the transmitted code is JavaScript.

10. A computer program product for integrating application functionality into a web page requested and rendered by a browser of a client computing system, comprising:
a computer readable storage medium having computer readable program code embodied therewith, the computer readable program code comprising:
computer readable program code configured to generate a script tag for embedding in a web page, the script tag identifying a location on a server from which to acquire script code to be executed when a browser of a client computing system processes the script tag;
computer readable program code configured to transmit the script code from the server to the browser in response to the browser processing the script tag;
computer readable program code configured to receive, at the server, a request for a data entry form in response to execution of the code by the browser;
computer readable program code configured to generate, at the server, the data entry form in response to the request from the browser; and
computer readable program code configured to transmit, from the server, the generated data entry form to the browser.

11. The computer program product of claim 10, further comprising computer readable program code configured to receive, at the server, user-supplied input to configure attributes of the data entry form; and
computer readable program code for configuring the data entry form at the server in accordance with the configured attributes before the data entry form is transmitted from the server to the browser.

12. The computer program product of claim 10, further comprising computer readable program code configured to receive user-supplied input to reconfigure attributes of the data entry form and, thereby, to change subsequent screen presentations of the data entry form, without modifying the script tag embedded on the web page.

13. The computer program product of claim 10, further comprising computer readable program code configured to maintain, at the server, a state of user interaction with the data entry form.

14. The computer program product of claim 10, further comprising computer readable program code configured to communicate with the data entry form rendered by the browser in order for the server to produce a next screen presentation to be rendered on the client computing system based on a state of user interaction with the data entry form.

15. The computer program product of claim 14, wherein the next screen presentation is a next form.

16. The computer program product of claim 14, wherein the next screen presentation is a new web page.

17. The computer program product of claim 10, further comprising computer readable program code configured to capture at the server user input submitted through the data entry form; and
computer readable program code configured to determine at the server a next screen presentation to generate for display by the browser.

18. The computer program product of claim 10, wherein the script tag is a JavaScript tag and the script code is JavaScript.

19. A system for integrating application functionality into a web page, comprising:
a client computing system running a browser that requests a web page from a web server, the browser program processing a script tag embedded in the requested web page, the script tag identifying a location from which to acquire script code to be executed by the browser; and
a server computing system running an application that transmits the script code to the browser running on the client computer system in response to the browser processing the script tag, the application receiving a request for a data entry form in response to execution of the code by the browser, generating the data entry form in response to the request from the browser, and transmitting the generated data entry form to the browser.

20. The network of claim 19, wherein the application receives user-supplied input to initially configure attributes of the data entry form, configures the data entry form in accordance with the configured attributes before transmitting the data entry form to the browser, and receives user-supplied input to subsequently reconfigure attributes of the data entry form, and, thereby, to change subsequent screen presentations of the data entry form, without modifying the script tag embedded on the web page.
